(19) United States
(12) Patent Application Publication
(10) Pub. No.: US 2015/0316136 A1
(43) Pub. Date: Nov. 5, 2015

(54) METHOD FOR PRODUCING A BACKLASH-FREE TRANSMISSION STAGE

(71) Applicant: Magna Powertrain AG & Co KG, Lannach (AT)

(72) Inventor: Klaus Schnölzer, Kirchberg (AT)

(21) Appl. No.: 14/682,702

(22) Filed: Apr. 9, 2015

(30) Foreign Application Priority Data
Apr. 30, 2014 (DE) 10 2014 208 269.2

(51) Int. Cl. F16H 55/18

(52) U.S. Cl. CPC F16H 55/18

(57) ABSTRACT

A method is disclosed for setting an angular displacement of a scissors gearwheel configured to mesh with another wheel in a backlash-free transmission stage. The method includes the steps of fixing the two gear rim parts of the gearwheel in a position corresponding to a desired angular displacement, moving the teeth of the gearwheel and the wheel into backlash-free meshed engagement, fixing the relative position between the gearwheel and the wheel, and cancelling the fixing of the two gear rim parts of the gearwheel.

### CROSS-REFERENCE TO RELATED APPLICATIONS

This application claims the benefit and priority of German Application No. 102014208269.2 filed Apr. 30, 2014. The entire disclosure of the above application is incorporated herein by reference.

### TECHNICAL FIELD

The present disclosure relates to a method for producing a backlash-free transmission stage by setting an angular displacement of a scissors gearwheel of the backlash-free transmission stage, wherein the gearwheel has a gear rim provided with teeth and which includes of a first gear rim part and a second gear rim part arranged coaxially with the first gear rim part, wherein the two gear rim parts can be turned relative to one another about an axis of rotation of the gearwheel, and wherein the gearwheel is fitted with a spring, situated between the two gear rim parts, which acts in the circumferential direction and preloads the two gear rim parts relative to one another. More specifically, the method is characterized by setting a desired angular displacement of the gearwheel by fixing the two gear rim parts relative to one another in a position corresponding to a desired angular displacement; bringing the gearwheel and a rotatably mounted wheel, which is likewise provided with teeth and with which the gearwheel meshes in the transmission stage, closer together by movement relative to one another in a setting direction normal to the axis of rotation as far as a relative position in which the teeth of the wheel and of the teeth of the gearwheel are in backlash-free engagement; fixing the relative position of the wheel and of the gearwheel, at least in the setting direction; and cancelling the fixing of the two gear rim parts of the gearwheel.

### BACKGROUND

This section provides background information related to the present disclosure which is not necessarily prior art.

In transmission stages, it may be the case that, owing to a desire for low noise levels for example, use is made of one or more gearwheels designed so that they do not have any backlash relative to one or more wheels meshing with said gearwheel when it comes to turning of a wheel relative to the gearwheel.

A gearwheel for performing such a task, commonly referred to as a divided gearwheel, a scissors gearwheel or as a “split gear” for use in a backlash-free transmission stage, is known.

DE 7345374 discloses a backlash-free transmission stage in which a wheel of an intermeshing gearwheel pair, primarily the driving wheel, is embodied as a scissors gearwheel, which has a gear rim which is divided along a parting plane extending normally to an axis of rotation of the gearwheel into two gear rim parts, which are mounted so as to be rotatable relative to one another coaxially around the axis of rotation and are preloaded by a spring situated between them and acting in a circumferential direction. One of the two gear rim parts is used for torque transmission, whereas the other performs backlash compensation.

DE 203 13 595 U1 discloses a method for mounting a scissors gearwheel in a transmission stage. For this purpose, the two gear rim parts of the scissors gearwheel or first of all fixed with the aid of an assembly fixture in a zero position, in which the teeth of the first gear rim part and the teeth of the second gear rim part are n alignment with one another in adjacent cross sections of the first gear rim part and the second gear rim part normal to the axis of rotation. The scissors gearwheel is then pushed onto a shaft of the transmission stage by means of its gear rim parts, which are fixed in the zero position, and are positioned relative to the wheel which meshes with the scissors gearwheel in the transmission stage in such a way that the teeth of the gear rim parts of the preloaded scissors gearwheel situated in the zero position engage in the tooth gaps between the teeth of the wheel which meshes with the scissors gearwheel in the transmission stage. The assembly fixture is then removed. Owing to the preload, the teeth of the first gear rim part and the teeth of the second gear rim part of the gear rim of the scissors gearwheel come to rest on opposite flanks of the wheel which meshes with said gearwheel. A “circumferential backlash”, which indicates the angular displacement of the first gear rim part relative to the second gear rim part, when the scissors gearwheel is in engagement with the wheel which meshes with the scissors gearwheel in the transmission stage, is determined exclusively by the meshing wheel up to a maximum circumferential backlash, which is limited by bushings fixed in the first gear rim part, which extend into corresponding recesses of larger configuration in the second gear rim part.

U.S. Pat. No. 1,648,715 likewise discloses the practice, in the case of a scissors gearwheel, of providing a maximum circumferential backlash which is limited by pins fixed in the first gear rim part and which extend into corresponding recesses of larger configuration in the second gear rim part.

The disadvantage thereof is that it is not possible to exert an external influence on the circumferential backlash, the circumferential backlash being determined exclusively by tolerances of the centre distance of the shafts of the scissors gearwheel and of the wheel which meshes with the latter and by tolerances of the teeth of the meshing wheel. If there is circumferential backlash close to the zero position after assembly, this results in high contact forces of the teeth of the first gear rim part and the teeth of the second gear rim part of the gear rim of the scissors gearwheel on opposite flanks of the wheel which meshes with the scissors gearwheel, this being associated with high wear. Moreover, assembly is very involved owing to the fixing of the scissors gearwheel in the zero position thereof.

To eliminate this disadvantage, DE 231425 discloses the practice of limiting the angular displaceability of the gear rim parts relative to one another in a controllable manner. For this purpose, means which resiliently hinder angular displacement are provided, said means acting through leverage. The means which resiliently hinder angular displacement can comprise an adjusting screw acting between the first and the second gear rim part.

DE 90 15 184 U1 discloses the practice of correctly setting two intermeshing wheels of a gearwheel pair, which are each mounted rotatably on a shaft, by moving the mounting of one of the shafts in a setting direction relative to the other shaft.

DE 20 2005 019 349 A1 discloses a gearwheel which has a gear rim which is divided along a parting plane extending normally to an axis of rotation of the gearwheel into two gear rim parts, which are mounted so as to be rotatable relative to one another coaxially around the axis of rotation. The two gear rim parts can be secured against angular displacement relative to one another by non-positive and/or positive engagement by means of a fastening element in the assembled state of the gearwheel. At least one tooth of the gear rim can be provided with a detachable coating, which allows simple running in of a transmission stage fitted with a gearwheel of this kind.

In view of the above, a recognized need exists to provide alternative methods for setting the angular displacement of a scissors gearwheel of the type adapted for use in a backlash-free transmission stage which overcomes the shortcomings of other known methods.

### SUMMARY

This section provides a general summary of the present disclosure and is not a comprehensive disclosure of its full scope or all of its objects, aspects and features.

It is an object of the present disclosure to provide an alternative method for producing a backlash-free transmission stage by setting the angular displacement of a scissors gearwheel of the backlash-free transmission stage.

The object is achieved by the features of the independent claim. In particular, the present disclosure provides a method for producing a backlash-free transmission stage by setting an angular displacement of a scissors gearwheel of the backlash-free transmission stage. The gearwheel has a gear rim having teeth and which includes a first gear rim part and a second gear rim part that is arranged coaxially with the first gear rim part such that the two gear rim parts can be turned relative to one another about an axis of rotation of the gearwheel. The gearwheel is fitted with a spring which is situated between the two gear rim parts and acts in the circumferential direction to preload the two gear rim parts relative to one another. The method of the present disclosure includes: first of all setting of a desired angular displacement of the gearwheel by fixing the two gear rim parts relative to one another in a position corresponding to a desired angular displacement; then bringing the gearwheel, which is mounted so as to be rotatable about the axis of rotation, and a rotatably mounted wheel, which is likewise provided with teeth and with which the gearwheel meshes in the transmission stage, closer together by movement relative to one another in a setting direction normal to the axis of rotation until a relative position is reached in which the teeth of the wheel and the teeth of the gearwheel are in backlash-free engagement; then fixing the mountings of the wheel and of the gearwheel, at least in the setting direction, in the relative position thereof in which the teeth thereof are in backlash-free engagement; and finally, cancelling the fixing of the two gear rim parts of the gearwheel.

The term “angular displacement” describes the turning of the first gear rim part relative to the second gear rim part. Consequently, it describes angular displacement of the two gear rim parts relative to one another.

In this case, the mountings of the wheel and of the gearwheel are fixed relative to one another, at least in the setting direction, in the relative position thereof in which the teeth thereof are in backlash-free engagement with one another by fixing the relative position attained. The rotatable mounting of the gearwheel and of the wheel which meshes with the gearwheel in the transmission stage is neither inhibited nor fixed, only the relative position between the gearwheel and the wheel which meshes with the latter in the transmission stage being fixed in the setting direction. If additional fixing in a direction different from the setting direction is required in order to fix the relative position, this is performed in the same method step or in a preceding or following method step.

The setting direction is parallel to a direction normal to the axis of rotation.

The axis of rotation is a geometrical feature, similar to a mirror axis or axis of rotational symmetry, not a feature in the sense of a mechanical element, such as a shaft.

The axis of rotation is normal to a plane enclosed by the gear rim and/or formed by the latter. For example, this plane can be a parting plane which divides the gear rim into its gear rim parts.

The axis of rotation passes through the centre of the gear rim, which coincides with the geometrical centre of gravity of the gear rim, when viewed in a plane extending orthogonally to the axis of rotation.

The gearwheel is primarily the driving wheel of the backlash-free transmission stage.

The gear rim can be divided along a parting plane extending normally to an axis of rotation of the gearwheel into the two gear rim parts arranged coaxially with one another.

One of the two gear rim parts is preferably used for torque transmission, whereas the other performs backlash compensation.

The wheel with which the gearwheel meshes in the transmission stage can be mounted so as to be rotatable about an axis of rotation of the wheel which extends parallel to the axis of rotation. In this case, the transmission stage is a spur wheel transmission stage. It is also conceivable for the axis of rotation of the wheel to intersect the axis of rotation, being arranged orthogonally with respect thereto for example. In this case, the transmission stage is a bevel wheel transmission stage. A skewed arrangement of the axis of rotation and the axis of rotation of the wheel is likewise conceivable. In this ease, the transmission stage can be a worm wheel transmission stage, for example.

The position corresponding to a desired angular displacement, in which the two gear rim parts are fixed relative to one another, is preferably greater than a zero position, in which the teeth of the first gear rim part and the teeth of the second gear rim part are in alignment with one another in adjacent cross sections of the first gear rim part and of the second gear rim part normal to the axis of rotation.

The position corresponding to a desired angular displacement, in which the two gear rim parts are fixed relative to one another, corresponds at most to a halfway position, in which the teeth of the first gear rim part and the teeth of the second gear rim part are each situated precisely centrally in tooth gaps formed between adjacent teeth of a gear rim part in adjacent cross sections of the first gear rim part and of the second gear rim part normal to the axis of rotation.

The wheel with which the gearwheel meshes in the transmission stage can be part of a module having at least one further wheel which meshes with the wheel.

To allow them to be brought closer together until the teeth of the wheel and the teeth of the gearwheel are in backlash-free engagement with one another, the gearwheel and the wheel which meshes with the gearwheel in the transmission stage, or the mountings of the wheel and of the gearwheel, can be fastened by means of slotted holes in such a way that they can be moved in the setting direction normally to the axis of rotation.

To fix the relative position of the gearwheel and the wheel which meshes with the gearwheel in the transmission stage or to fix the mountings of the wheel and of the gearwheel, which are fastened by means of slotted holes in such a way that they can be moved in the setting direction normally to the axis of rotation, after they have been brought closer together until the teeth of the wheel and of the gearwheel are in backlash-free engagement, dowel sleeves can be provided.

The transmission stage is preferably a mass balancing system, the mass balancing by which can be set very precisely by selective setting of the angular displacement of the two gear rim parts of the gearwheel relative to one another. The transmission stage can include such a mass balancing system or can be part of a mass balancing system or can be included by a mass balancing system.

Movement and adjustment, in the setting direction, of the gearwheel and of the wheel which meshes with the gearwheel in the transmission stage is preferably accomplished by means of slotted holes provided in a housing, e.g. a crankcase, e.g. that of a mass balancing system.

In addition to the wheel which meshes with the gearwheel, the mass balancing system can have a further wheel, which rotates in the opposite direction to the wheel which meshes with the gearwheel. This can likewise be in engagement with the gearwheel but is preferably in engagement with the wheel which meshes with the gearwheel

Apart from complete achievement of the stated object, advantages over the prior art are obtained through elimination of all the disadvantages of the prior art, inter alia by setting a desired angular displacement of the two gear rim parts relative to one another through deliberate setting of a misalignment between the first and the second gear rim part on the gearwheel by fixing the gearwheel in a position corresponding to a desired angular displacement. The misalignment between the first and the second gear rim pan forms a defined overlap, which increases the apparent tooth width of the gearwheel and thereby determines the desired angular displacement.

Further areas of applicability will become apparent from the description provided herein. The description and specific examples in this summary are intended for purposes of illustration only and are not intended to limit the scope of the present disclosure.

### DRAWINGS

The invention and the advantages thereof are explained in greater detail below by means of example embodiments illustrated in the figures. The size ratios of the individual elements in the figures do not always correspond to the actual size ratios since, in the figures, some of the shapes are simplified and other shapes are illustrated on an enlarged scale in relation to other elements for greater clarity. Identical reference signs are used for elements of the invention which are the same or have the same action. Moreover, only reference signs which are required to describe the respective figure are illustrated in the individual figures for the sake of comprehension. The embodiments illustrated are merely examples of how the method according to the invention can be embodied and do not represent an exclusive selection. In schematic representation:

FIG. 1 illustrates a scissors gearwheel in a perspective view;

FIG. 2 illustrates the scissors gearwheel from FIG. 1 in a view normal to the axis of rotation thereof; and

FIG. 3 illustrates a backlash-free transmission stage fitted with as scissors gearwheel, in a partially sectioned side view.

### DESCRIPTION

Example embodiments of a scissors gearwheel and a backlash-free transmission stage equipped with the scissors gearwheel are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

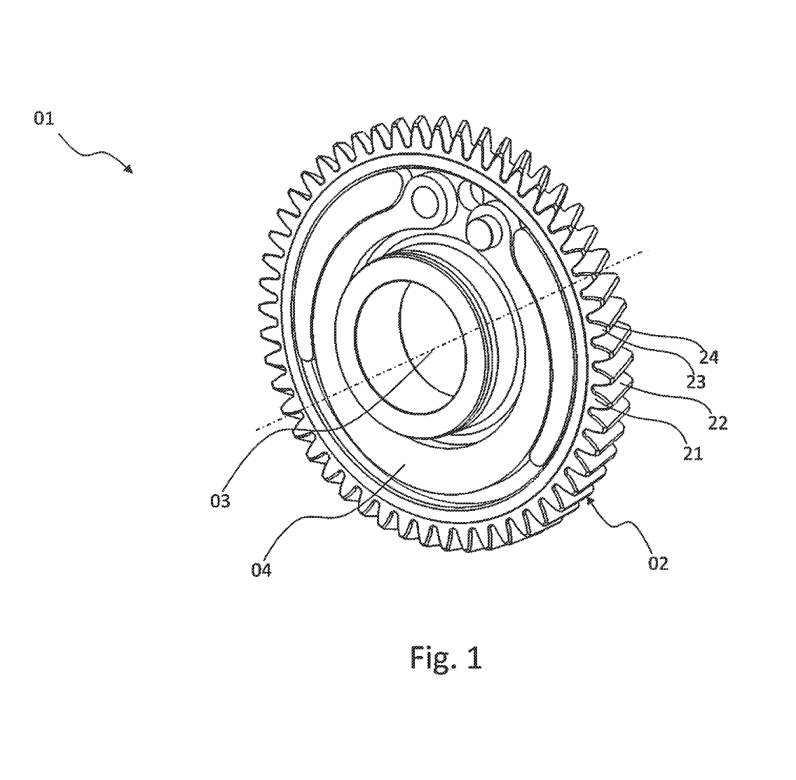

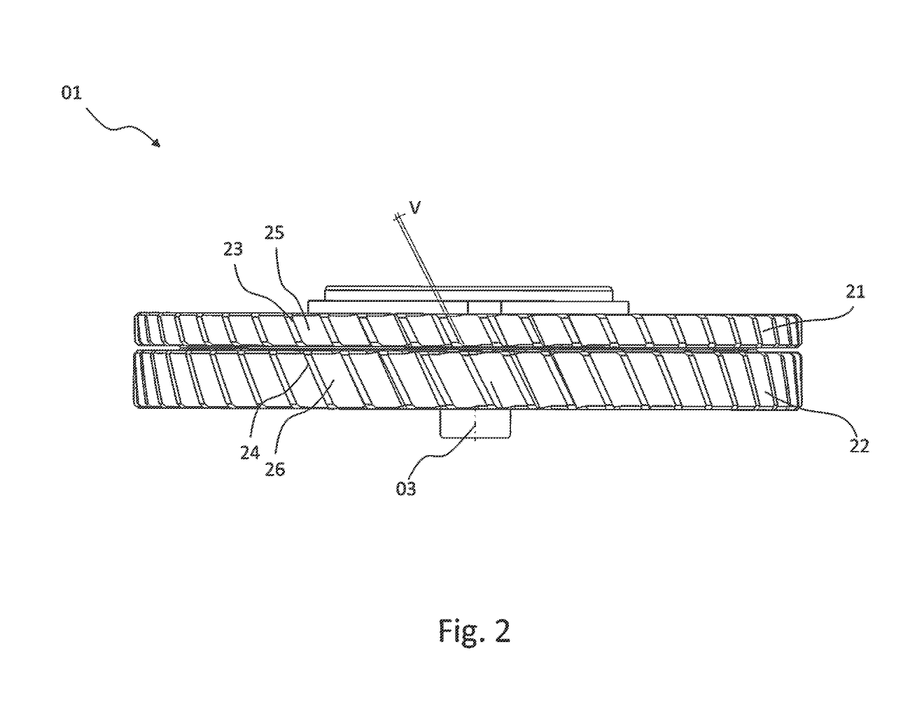

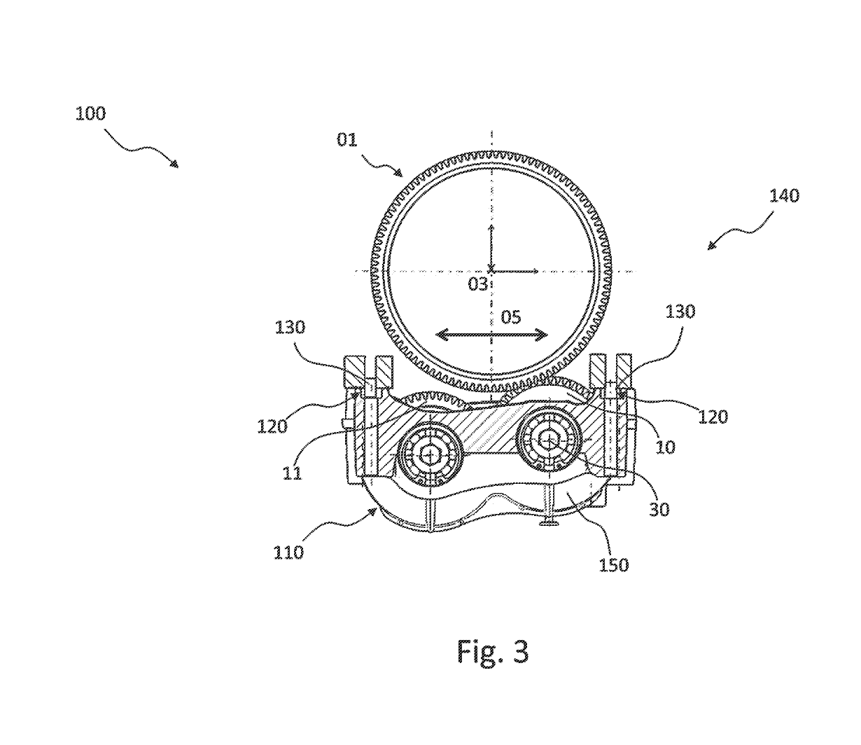

A scissors gearwheel 01, illustrated fully or partially in FIG. 1 and in FIG. 2, for use in a backlash-free transmission stage 100, illustrated in FIG. 3, comprises a gear rim 02 provided with teeth. The gear rim 02 includes of as first gear rim part 21 and a second gear rim part 22 arranged coaxially therewith.

The two gear rim parts 21, 22 can be turned relative to one another about an axis 03 of rotation of the gearwheel 01. The axis 03 of rotation is normal to a plane enclosed by the gear rim 02 and/or formed by the latter. This plane can be a parting plane which divides the gear rim 02 into the gear rim parts 21, 22 thereof, for example.

The scissors gearwheel 01 comprises at least one spring 04 situated between the two gear rim parts 21, 22 and which acts in the circumferential direction. The spring 04 preloads the two gear rim parts 21, 22 relative to one another.

A method for setting the angular displacement “V” between the two gear rim parts 21, 22 of the scissors gearwheel 01, illustrated fully or in parts in FIG. 1 and in FIG. 2, used in the backlash-free transmission stage 100, illustrated in FIG. 3, first of all provides for setting a desired angular displacement V of the gearwheel 01. For this purpose, the two gear rim parts 21, 22 are fixed relative to one another in a position corresponding to a desired angular displacement V, as illustrated in FIG. 2.

The position corresponding to the desired angular displacement V, in which the two gear rim parts 21, 22 are fixed relative to one another, is preferably larger than a zero position illustrated in FIG. 1, in which the teeth 23 of the first gear rim part 21 and the teeth 24 of the second gear rim part 22 are in alignment with one another in adjacent cross sections of the first gear rim part 21 and of the second gear rim part 22 normal to the axis of rotation.

The position corresponding to the desired angular displacement V, in which the two gear rim parts 21, 22 are fixed relative to one another, preferably corresponds at most to a halfway position, in which the teeth 23 of the first gear rim part 21 are each situated precisely centrally in tooth gaps 26 formed between adjacent teeth 24 of the second gear rim part 22 in adjacent cross sections of the first gear rim part 21 and of the second gear rim part 22 normal to the axis 03 of rotation, and the teeth 24 of the second gear rim part 22 are each situated precisely centrally in tooth gaps 25 formed between adjacent teeth 23 of the first gear rim part 21 in adjacent cross sections of the first gear rim part 21 and of the second gear rim part 22 normal to the axis 03 of rotation.

After setting the angular displacement V and fixing the gear rim parts 21, 22 of the gearwheel 01 in a position corresponding to the angular displacement V, the method envisages that the gearwheel 01, which is mounted so as to be rotatable about the axis 03 of rotation, and a rotatably mounted wheel 10, which is likewise provided with teeth and with which the gearwheel 01 meshes in the transmission stage 100, should be brought closer relative to one another by movement in a setting direction, as indicated by a double arrow 05 in FIG. 3. The setting direction being normal to the axis 03 of rotation, which is perpendicular to the plane of the drawing in FIG. 3, as far as a relative position in which the teeth of the wheel 10 and of the gearwheel 01 are in backlash-free engagement with one another. The setting direction is parallel to a direction normal to the axis 03 of rotation.

The method then provides for fixing the relative position of the wheel 10 and of the gearwheel 01, in which such relative position the teeth thereof are in backlash-free engagement, the fixing being at least in the setting direction indicated by a double arrow 05 in FIG. 3, without inhibiting or impairing the rotatable mounting either of the gearwheel 01 or of the wheel 10 which meshes with the latter in the transmission stage 100.

Finally, the method envisages cancelling the fixing of the two gear rim parts 21, 22 of the gearwheel 01.

The wheel 10 with which the gearwheel 01 meshes in the transmission stage 100 can be mounted so as to be rotatable about an axis 30 of rotation of the wheel which is perpendicular to the plane of the drawing in FIG. 3 and which extends parallel to the axis 03 of rotation. In this case, the transmission stage 100 is a spur wheel transmission stage.

As an alternative, the wheel 10 with which the gearwheel 01 meshes in the transmission stage 100 can he mounted so as to be rotatable about an axis of rotation of the wheel which intersects the axis 03 of rotation. In this case, the transmission stage 100 is a bevel wheel transmission stage, for example.

As an alternative, the wheel 10 with which the gearwheel 01 meshes in the transmission stage 100 is mounted so as to be rotatable about an axis of rotation of the wheel which is arranged askew relative to the axis 03 of rotation. In this case, the transmission stage 100 can be a worm wheel transmission stage.

The wheel 10 with which the gearwheel 01 meshes in the transmission stage 100 can be part of a module 110 having at least one further wheel 11 meshing with the wheel 10.

The gearwheel 01 and the wheel 10 which meshes with the gearwheel 01 in the transmission stage 100, or the mountings of the wheel 10 and of the gearwheel 01, can be fastened by means of slotted holes 120 in such a way that they can be moved in the setting direction indicated by a double arrow 05 in FIG. 3 normally to the axis 03 of rotation in order to bring them closer together until the teeth of the wheel 10 and the teeth of the gearwheel 01 are in backlash-free engagement with one another.

Dowel sleeves 130 can be provided to fix the relative position of the gearwheel 01, which is fastened, for example, by means of slotted holes 120 in such a way that it can be moved normally to the axis 03 of rotation in the setting direction indicated by a double arrow 05 in FIG. 3, and of the wheel 10, which meshes with the gearwheel 01 in the transmission stage 100 and, as an alternative or in addition, is fastened by means of slotted holes 120, for example, in such a way that it can be moved normally to the axis 03 of rotation in the setting direction indicated by a double arrow 05 in FIG. 3, or to fix the mountings of the wheel 10 and of the gearwheel 01 after they have been brought closer together until the teeth of the wheel 10 and of the gearwheel 01 are in backlash-free engagement with one another.

The transmission stage 100 is preferably a mass balancing system 140, the mass balancing of which can be set very precisely by selective setting of the angular displacement V of the two gear rim parts 21, 22 of the gearwheel 01 relative to one another. As an alternative, the transmission stage 100 includes such a mass balancing system 140 or is part of a mass balancing system or is included by a mass balancing system.

In addition to the wheel 10 which meshes with the gearwheel 01, the mass balancing system 140 can have a further wheel 11, which rotates in the opposite direction to the wheel 10 which meshes with the gearwheel 01. This can likewise be in engagement with the gearwheel 01 but is preferably in engagement with the wheel 10 which meshes with the gearwheel 01, as illustrated in FIG. 3.

Movement and adjustment, in the setting direction indicated by a double arrow 05 in FIG. 3, of the gearwheel 01 and of the wheel 10 which meshes with the gearwheel 01 in the transmission stage 100 is, as a particularly preferred option, accomplished by means of slotted holes 120 provided in a housing 150, e.g. a crankcase, e.g. that of a mass balancing system 140.

The gearwheel 01 is primarily the driving wheel of the backlash-free transmission stage 100.

One of the two gear rim parts 21, 22 is preferably used for torque transmission, whereas the other performs backlash compensation.

The invention is industrially applicable especially in the area of production of scissors gearwheels 01 and transmission stages 100 fitted therewith, e.g. mass balancing systems 140.

The invention has been described with reference to a preferred embodiment. However, as a person skilled in the art will understand, modifications or changes to the invention can be made without exceeding the scope of protection of the following claims.

What is claimed is:

1. A method for producing a backlash-free transmission stage comprising the setting of an angular displacement of a scissors gearwheel of the backlash-free transmission stage, wherein the gearwheel has a gear rim, which is provided with teeth and which includes a first gear rim part and a second gear rim part arranged coaxially with the first gear rim part, wherein the two gear rim parts can be turned relative to one another about an axis of rotation of the gearwheel, and wherein the gearwheel is fitted with a spring, which is situated between the two gear rim parts and acts in the circumferential direction to preload the two gear rim parts relative to one another, characterized by the following method steps:
setting a desired angular displacement of the gearwheel by fixing the two gear rim parts relative to one another in a position corresponding to a desired angular displacement;
bringing the gearwheel, which is mounted so as to be rotatable about the axis of rotation, and a rotatably mounted wheel, which is likewise provided with teeth and with which the gearwheel meshes in the transmission stage, closer together by movement relative to one another in a setting direction normal to the axis of rotation as far as a relative position in which the teeth of the wheel and the teeth of the gearwheel are in backlash-free engagement;
fixing the relative position of the wheel and of the gearwheel, at least in the setting direction; and
canceling the fixing of the two gear rim parts of the gearwheel.

2. The method in accordance with claim 1, wherein the wheel with which the gearwheel meshes in the transmission stage is mounted so as to be rotatable about an axis of rotation of the wheel which extends parallel to the axis of rotation of the gearwheel.

3. The method in accordance with claim 1, wherein the wheel with which the gearwheel meshes in the transmission stage is mounted so as to be rotatable about an axis of rotation of the wheel which intersects the axis of rotation of the gearwheel

4. The method in accordance with claim 1, wherein the wheel with which the gearwheel meshes in the transmission stage is mounted so as to be rotatable about an axis of rotation of the wheel which is arranged askew relative to the axis of rotation of the gearwheel.

5. The method in accordance with claim 1, wherein the position corresponding to a desired angular displacement, in which the two gear rim parts are fixed relative to one another, is greater than a zero position defined by the teeth of the first gear rim part and the teeth of the second gear rim part being in alignment with one another in adjacent cross sections of the first gear rim part and of the second gear rim part normal to the axis of rotation.

6. The method in accordance with claim 1, wherein the position corresponding to a desired angular displacement, in which the two gear rim parts are fixed relative to one another, corresponds at most to a halfway position defined by the teeth of the first gear rim part and the teeth of the second gear rim part each being precisely central in tooth gaps formed between adjacent teeth of a gear rim part in adjacent cross sections of the first gear rim part and of the second gear rim part normal to the axis of rotation.

7. The method in accordance with claim 1, wherein the wheel with which the gearwheel meshes in the transmission stage is part of a module having at least one further wheel meshing with the wheel.

8. The method in accordance with claim 1, wherein the gearwheel and the wheel which meshes with the gearwheel in the transmission stage are moved in the setting direction normally to the axis of rotation by means of slotted holes in order to bring them closer together.

9. The method in accordance with claim 1, wherein, after the gearwheel and the wheel which meshes with the latter in the transmission stage have been brought closer together, dowel sleeves are used to fix the relative position thereof.

10. The method in accordance with claim 1, wherein the transmission stage is a mass balancing system, or the transmission stage includes such a mass balancing system or is part of a mass balancing system or is included by a mass balancing system.

11. The method in accordance with claim 10, wherein, in addition to the wheel which meshes with the gearwheel, the mass balancing system has a further wheel, which rotates in the opposite direction to the wheel which meshes with the gearwheel.

12. The method in accordance with claim 1, wherein movement and adjustment in the setting direction of the gearwheel and of the wheel which meshes with the gearwheel in the transmission stage is accomplished by means of slotted holes provided in as housing.

13. A method for producing a backlash-free transmission stage, comprising:
providing a scissors gearwheel having a gear rim with teeth, the gear rim including a first gear rim part and a second gear rim part arranged coaxially with the first gear rim part for relative rotation about an axis of rotation, the scissors gearwheel including a spring situated between the first and second gear rim parts and acting in a circumferential direction to preload the two gear rim parts relative to each other;
setting a desired angular displacement of the gearwheel by fixing the first and second gear rim parts relative to each other in a desired position corresponding to the desired angular displacement;
providing a rotatably mounted wheel having teeth adapted to mesh with the teeth of the gearwheel in the transmission stage;
bringing the gearwheel and the wheel closer together by movement in a setting direction normal to the axis of rotation of the gearwheel into a relative position whereat the teeth of the gearwheel and the teeth of the wheel are meshed in backlash-free engagement;
fixing the relative position of the wheel and the gearwheel; and
cancelling the fixing of the first and second gear rim parts from the desired position.

14. The method in accordance with claim 13, wherein the wheel is mounted for rotation about an axis of rotation which extends parallel to the axis of rotation of the gearwheel.

15. The method in accordance with claim 13, wherein the wheel is mounted for rotation about an axis of rotation which intersects the axis of rotation of the gearwheel.

16. The method in accordance with claim 13, wherein the desired positions corresponding to the desired angular displacement in which the two gear rim parts are fixed relative to one another, is greater than a zero position defined by the teeth of the first gear rim part and the teeth of the second gear rim part being in alignment with one another in adjacent cross sections of the first gear rim part and of the second gear rim part normal to the axis of rotation.

17. The method in accordance with claim 13, wherein the desired position corresponding to a desired angular displacement in which the two gear rim parts are fixed relative to one another, corresponds at most to a halfway position defined by the teeth of the first gear rim part and the teeth of the second gear rim part each being precisely central in tooth gaps formed between adjacent teeth of a gear rim part in adjacent cross sections of the first gear rim part and of the second gear rim part normal to the axis of rotation.

18. The method in accordance with claim 13, wherein the wheel with which the gearwheel meshes in the transmission stage is part of a module having at least one further wheel meshing with the wheel.

19. The method in accordance with claim 13, wherein the transmission stage is a mass balancing system, or the transmission stage includes such a mass balancing system or is part of a mass balancing system or is included by a mass balancing system, and wherein the mass balancing system includes a further wheel which rotates in the opposite direction to the wheel.

20. The method in accordance with claim 13, wherein movement and adjustment in the setting direction of the gearwheel and of the wheel which meshes with the gearwheel in the transmission stage is accomplished by means of slotted holes provided in a housing.
